(19) United States
(12) Patent Application Publication
(10) Pub. No.: US 2023/0058706 A1
(43) Pub. Date: Feb. 23, 2023

(54) METHOD, DEVICE AND COMPUTER STORAGE MEDIUM OF COMMUNICATION

(71) Applicant: NEC Corporation, Minato-ku, Tokyo (JP)

(72) Inventors: Lin LIANG, Beijing (CN); Gang WANG, Beijing (CN)

(73) Assignee: NEC Corporation, Minato-ku, Tokyo (JP)

(21) Appl. No.: 17/793,707

(22) PCT Filed: Jan. 22, 2020
(86) PCT No.: PCT/CN2020/073897

§ 371 Date: Jul. 19, 2022

(51) Int. Cl. H04W 76/30; H04W 52/02; H04W 48/10; H04W 72/14; H04W 72/12

(52) U.S. Cl. CPC H04W 76/30; H04W 52/0229; H04W 48/10; H04W 72/14; H04W 72/1289

(57) ABSTRACT

Embodiments of the present disclosure relate to methods, devices and computer readable media of communication. A method of communication implemented by a terminal device comprises generating, in an inactive state, a first control element of a media access control layer, the first control element carrying a first identity of the terminal device; and transmitting, to a network device, the first control element and uplink data. The method of communication implemented by a network device comprises receiving the first control element and uplink data from the terminal device; and transmitting the uplink data to a core network element. In this way, small data transmission can be achieved in an inactive state of the terminal device with reduced signaling overhead.

### TECHNICAL FIELD

Embodiments of the present disclosure generally relate to the field of telecommunication, and in particular, to methods, devices and computer storage media of communication for small data transmission.

### BACKGROUND

Typically, a terminal device in an inactive state may still have small and infrequent data traffic (also referred to as small data transmission hereinafter) to be transmitted. Until the third generation partnership project (3GPP) Release 16, the inactive state cannot support data transmission, and the terminal device has to resume the connection for any downlink and uplink data. Connection setup and subsequently release to the inactive state happens for each data transmission whatever small and infrequent the data packets are.

This will result in unnecessary power consumption and signaling overhead.

In this event, 3GPP Release 17 has approved small data transmission based on a random access channel (RACH) in the inactive state. The signaling overhead can be further reduced if the small data transmission can be performed without a radio resource control (RRC) message. Thus, how to perform the small data transmission without RRC signaling has become a hot issue.

### SUMMARY

In general, embodiments of the present disclosure provide methods, devices and computer storage media of communication for small data transmission.

In a first aspect, there is provided a method of communication. The method comprises: generating, at the terminal device in an inactive state, a first control element of a media access control layer, the first control element carrying a first identity of the terminal device; and transmitting, to a network device, the first control element and uplink data.

In a second aspect, there is provided a method of communication. The method comprises: receiving, at a network device, a first control element of a media control layer and uplink data from a terminal device, the first control element carrying a first identity of the terminal device; and transmitting the uplink data to a core network element.

In a third aspect, there is provided a terminal device. The terminal device comprises a processor and a memory coupled to the processor. The memory stores instructions that when executed by the processor, cause the terminal device to perform the method according to the first aspect of the present disclosure.

In a fourth aspect, there is provided a network device. The network device comprises a processor and a memory coupled to the processor. The memory stores instructions that when executed by the processor, cause the network device to perform the method according to the second aspect of the present disclosure.

In a fifth aspect, there is provided a computer readable medium having instructions stored thereon. The instructions, when executed on at least one processor, cause the at least one processor to perform the method according to the first aspect of the present disclosure.

In a sixth aspect, there is provided a computer readable medium having instructions stored thereon. The instructions, when executed on at least one processor, cause the at least one processor to perform the method according to the second aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 illustrates a schematic diagram illustrating a process of communication for small data transmission according to some embodiments of the present disclosure;

FIG. 3 illustrates a schematic diagram illustrating a process of communication during a 4-step RACH procedure according to some embodiments of the present disclosure;

FIG. 4 illustrates a schematic diagram illustrating a process of communication during a 2-step RACH procedure according to some embodiments of the present disclosure;

FIG. 5 illustrates an example method of communication implemented at a terminal device in accordance with some embodiments of the present disclosure;

FIG. 6 illustrates a schematic diagram illustrating an implementation of a control element of media access control layer (MAC CE) carrying a first identity and first authentication information for the terminal device in accordance with some embodiments of the present disclosure;

FIG. 7 illustrates a schematic diagram illustrating another implementation of a MAC CE carrying a first identity and first authentication information for the terminal device in accordance with some embodiments of the present disclosure;

FIG. 8 illustrates a schematic diagram illustrating an implementation of a MAC CE carrying contention resolution information for a 4-step RACH procedure in accordance with some embodiments of the present disclosure;

FIG. 9 illustrates a schematic diagram illustrating an implementation of a successful random access response (RAR) carrying contention resolution information for a 2-step RACH procedure in accordance with some embodiments of the present disclosure;

FIG. 10 illustrates another example method of communication implemented at a terminal device in accordance with some embodiments of the present disclosure;

FIG. 11 illustrates another example method of communication implemented at a terminal device in accordance with some embodiments of the present disclosure;

FIG. 12 illustrates an example method of communication implemented at a network device in accordance with some embodiments of the present disclosure;

FIG. 13 illustrates another example method of communication implemented at a network device in accordance with some embodiments of the present disclosure; and

FIG. 14 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), a low power node such as a femto node, a pico node, and the like.

In one embodiment, the terminal device may be connected with a first network device and a second network device. One of the first network device and the second network device may be a master node and the other one may be a secondary node. The first network device and the second network device may use different RATs. In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

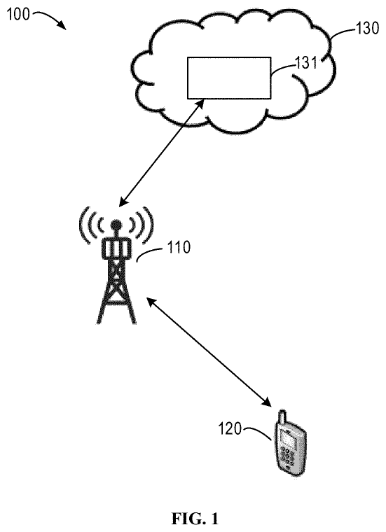

FIG. 1 illustrates a schematic diagram of an example communication network 100 in which embodiments of the present disclosure can be implemented. As shown in FIG. 1, the communication network 100 may include a network device 110 and a terminal device 120 served by the network device 110. The network device 110 may communicate with the terminal device 120 via a channel such as a wireless communication channel.

The communication network 100 may further include a core network element 131 which is located in a core network 130. For example, in some embodiments, the core network element 131 may perform a user plane function (UPF). It should be noted that the core network element 131 may perform any other additional functions, and the present application does not make limitation in this regard.

The terminal device 120 may communicate with the core network element 131 via the network device 110. For example, the terminal device 120 may transmit data packets (i.e., uplink data) to the network device 110, and the network device 110 may transmit the uplink data to the core network element 131. Accordingly, the core network element 131 may transmit data packets (i.e., downlink data) to the network device 110, and the network device 110 may transmit the downlink data to the terminal device 120.

It is to be understood that the number of devices in FIG. 1 is given for the purpose of illustration without suggesting any limitations to the present disclosure. The communication network 100 may include any suitable number of network devices and/or terminal devices and/or core network elements adapted for implementing implementations of the present disclosure.

The communications in the communication network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

As mentioned above, the terminal device 120 in an inactive state may still have small and infrequent data traffic to be transmitted. In some embodiments, the small and infrequent data traffic may include smartphone applications such as traffic from instant messaging (IM) services (whatsapp, QQ, wechat etc.), heart-beat/keep-alive traffic from IM/email clients and other applications, and push notifications from various applications. In some embodiments, the small and infrequent data traffic may include non-smartphone applications such as traffic from wearables (periodic positioning information etc.), sensors (Industrial Wireless Sensor Networks transmitting temperature, pressure readings periodically or in an event triggered manner etc.), and smart meters and smart meter networks sending periodic meter readings.

Currently, a RACH-based scheme without a RRC message has been proposed to perform small data transmission so as to reduce signaling overhead. However, no further detailed solutions are proposed. Embodiments of the present disclosure provide a solution of communication for small data transmission. The solution can achieve small data transmission in an inactive state of a terminal device with reduced signaling overhead. Principles and implementations of the present disclosure will be described in detail below with reference to the figures.

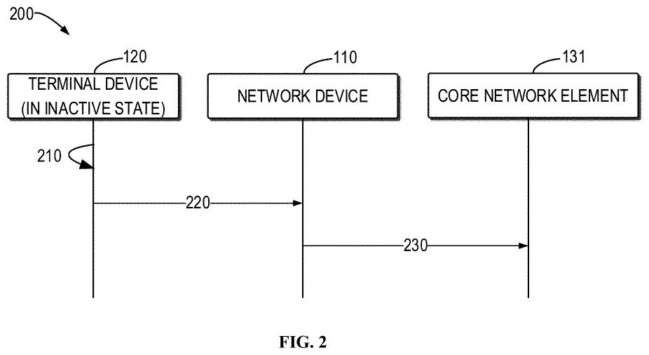

FIG. 2 illustrates a schematic diagram illustrating a process 200 of communication for small data transmission according to some embodiments of the present disclosure. For the purpose of discussion, the process 200 will be described with reference to FIG. 1. The process 200 may involve the terminal device 120, the network device 110 and the core network element 131 as illustrated in FIG. 1.

As shown in FIG. 2, the terminal device 120 in an inactive state generates 210 a first control element of a media access control layer (MAC CE). The first MAC CE carries a first identity of the terminal device 120. The first identity refers to an identity used by the terminal device 120 in the inactive state. In some embodiments, the first identity may be a temporary identity of the terminal device 120 in the inactive state, for example, an inactive radio network temporary identifier (I-RNTI).

In some embodiments, in accordance with a determination that uplink data to be transmitted at the terminal device 120 is associated with small and infrequent data traffic, the terminal device 120 may generate the first MAC CE. In some embodiments, the first MAC CE may be newly defined. In contrast with a RRC message carrying the first identity, the first MAC CE carrying the first identity can significantly reduce the signaling overhead.

Upon generating the first MAC CE, the terminal device 120 transmits the first MAC CE and the uplink data. In some embodiments, the terminal device 120 may transmit the first MAC CE and the uplink data in a physical uplink shared channel (PUSCH). In some embodiments, the terminal device 120 may transmit the first MAC CE and the uplink data during a 4-step RACH procedure. In some embodiments, the terminal device 120 may transmit the first MAC CE and the uplink data during a 2-step RACH procedure.

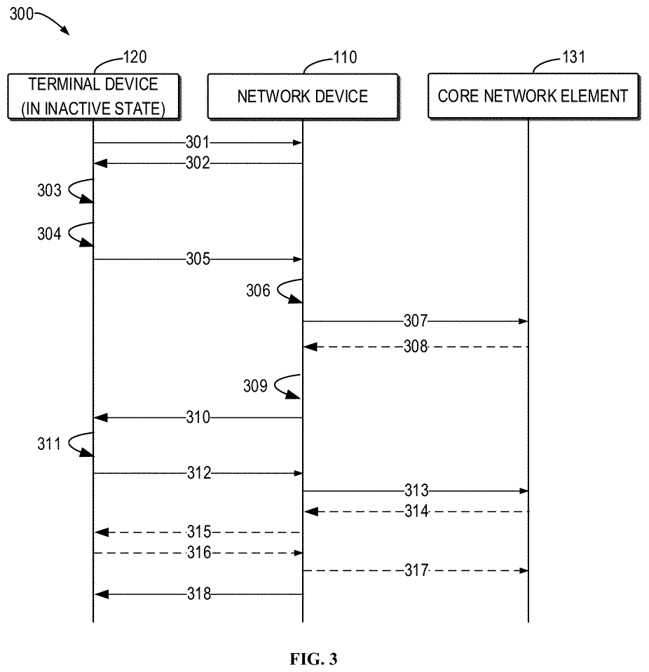

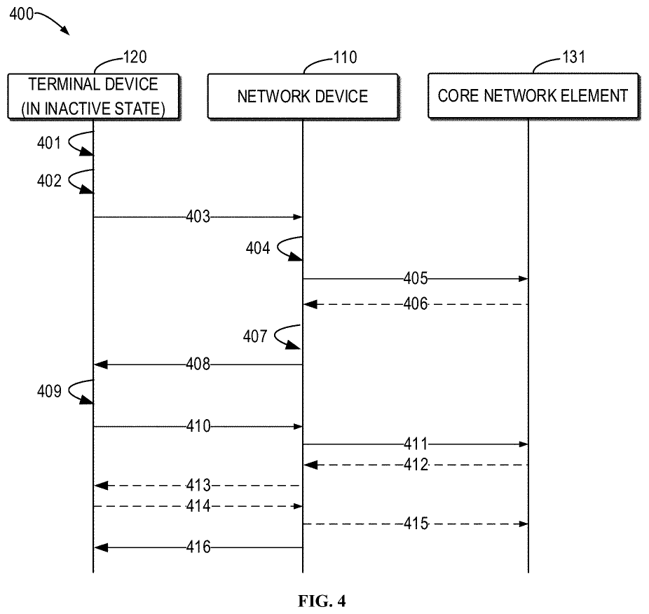

Accordingly, upon receiving the first MAC CE and the uplink data, the network device 110 transmits the uplink data to the core network element 131. In some embodiments, the terminal device 120 may just transmit the uplink data to the network device 110 and does not wait for any contention resolution. In this case, the network device 110 may configure no contention resolution timer or no RAR window for the terminal device 120. In some alternative embodiments, the terminal device 120 may receive the result of the contention resolution. It will be described in more details with reference to FIGS. 3 and 4.

FIG. 3 illustrates a schematic diagram illustrating a process 300 of communication during a 4-step RACH procedure according to some embodiments of the present disclosure. For the purpose of discussion, the process 300 will be described with reference to FIG. 1. The process 300 may involve the terminal device 120, the network device 110 and the core network element 131 as illustrated in FIG. 1.

As shown in FIG. 3, the terminal device 120 in the inactive state may transmit 301 a random preamble sequence to the network device 110. In some embodiments, the terminal device 120 may transmit the random preamble sequence in a RACH. In some embodiments, the terminal device 120 may transmit the random preamble sequence in accordance with a determination that uplink data to be transmitted at the terminal device 120 is associated with small and infrequent data traffic. Accordingly, the terminal device 120 may receive 302 a RAR from the network device 110. The RAR may include a temporary cell radio network temporary identifier (TC-RNTI).

Then the terminal device 120 may generate 303 a first MAC CE carrying a first identity of the terminal device 120 such as I-RNTI. In some embodiments, the first MAC CE may further carry first authentication information for the terminal device 120, and the first identity and the first authentication information are in different fields of the first MAC CE. In some alternative embodiments, the terminal device 120 may further generate 304 a second MAC CE carrying the first authentication information for the terminal device 120. The first authentication information is used to verify the validity of the terminal device 120 at the network device 110. For example, the first authentication information may be in the form of a short message authentication code for integrity (ShortMAC-I).

The terminal device 120 may transmit 305 the first MAC CE and the uplink data to the network device 110. In some embodiments where the terminal device 120 is needed to be verified by the network device 110, the terminal device 120 may transmit the first MAC CE, the uplink data and the second MAC CE to the network device 110. In some embodiments, the terminal device 120 may transmit the first MAC CE, the uplink data, the second MAC CE and a buffer status report (BSR) to the network device 110. The BSR may indicate amount of remaining uplink data that is to be transmitted.

For the transmission 305, the transmitted information is scrambled by the TC-RNTI. In some embodiments, an extended contention resolution timer may be started, as the network device 110 needs to forward uplink data to the core network element 131, and wait for downlink data from the core network element 131. In some embodiments for the 4-step RACH procedure, a longer contention resolution timer may be used, for example, ENUMERATED {sf8, sf16, sf24, sf32, sf40, sf48, sf56, sf64, sf80, sf100, sf120, sf160, sf200, sf240, sf480, sf960, sf1920, sf3840, sf5760, sf7680, sf10240}.

In some embodiments, the extended contention resolution timer may be broadcasted by the system information. In some alternative embodiments, the extended contention resolution timer may be configured to the terminal device 120 by using a dedicated RRC message.

In some embodiments where the terminal device 120 is needed to be verified by the network device 110, the network device 130 may determine the first authentication information from the second MAC CE, and verify 306 the validity of the terminal device 120 based on the first authentication information. In some embodiments, in accordance with a determination that the terminal device 120 is valid, the network device 130 may transmit 307 the uplink data to the core network element 131. In some embodiments, in accordance with a determination that the terminal device 120 is invalid, the network device 130 may discard the uplink data. In some embodiments where there is downlink data that is to be transmitted from the core network element 131, the network device 110 may receive 308 the downlink data from the core network element 131.

The network device 110 may generate 309 a third MAC CE carrying contention resolution information and transmit 310 the third MAC CE to the network device 110. In some embodiments, the contention resolution information may comprise an identity of a terminal device that is successful in contention resolution. In some embodiments, the network device 110 may transmit the third MAC CE in a physical downlink shared channel (PDSCH).

Assuming that the contention resolution information comprises the first identity of the terminal device 120. In some embodiments where the network device 110 is needed to be verified at the terminal device 120, the network device 110 may generate a fourth MAC CE carrying second authentication information for the network device 110. For example, the second authentication information may be in the form of a ShortMAC-I. In this case, the network device 110 may transmit the fourth MAC CE with the third MAC CE to the network device 110.

In some embodiments where the network device 110 receives a BSR indicating there is still have remaining uplink data to be transmitted, the network device 110 may transmit uplink grant information with the third MAC CE to the terminal device 120. In some additional embodiments, the network device 110 may transmit the third MAC CE, the fourth MAC CE, and uplink grant information to the terminal device 120.

In some embodiments the network device 110 receives, from the core network element 131, the downlink data destined for the terminal device 120, the network device 110 may transmit the third MAC CE, the fourth MAC CE, the uplink grant information and the downlink data to the network device 110.

Upon receiving the third MAC CE that comprises the first identity of the terminal device 120, the terminal device 120 may perform subsequent data transmission by using the TC-RNTI as a cell radio network temporary identifier (C-RNTI). In this time, the terminal device 120 is still in the inactive state.

In some embodiments, the terminal device 120 may verify 311 the validity of the network device 110 based on the second authentication information received from the network device 110. If the network device 110 is determined as being valid, the terminal device 120 may accept the received downlink data. If the network device 110 is determined as being invalid, the terminal device 120 may discard the received downlink data.

The terminal device 120 may transmit 312 the at least a part of the remaining uplink data and a BSR to the network device 130. In some embodiments, the terminal device 120 may monitor, in response to receiving the uplink grant information, a downlink channel until a period of time is expired. In some alternative embodiments, the terminal device 120 may monitor, in response to transmitting 312 at least a part of the remaining uplink data, a downlink channel until a period of time is expired.

Upon receiving the at least a part of the remaining uplink data, the network device 110 may transmit 313 it to the core network element 131. The network device 110 may receive 314 further downlink data and further uplink grant information if any, and transmit 315 them to the terminal device 120. The terminal device 120 may transmit 316 the remaining uplink data to the network device 110 and the network device 110 may transmit 317 it to the core network element 131.

The uplink and downlink data transmission may be repeated as above with C-RNTI in the inactive state of the terminal device 120 until the network device 110 transmits 318 a connection release message that indicates the end of the data transmission. If receiving the connection release message such as a RRCRelease message, the terminal device 120 may initialize the inactive state of the terminal device 120.

FIG. 4 illustrates a schematic diagram illustrating a process 400 of communication during a 2-step RACH procedure according to some embodiments of the present disclosure. For the purpose of discussion, the process 400 will be described with reference to FIG. 1. The process 400 may involve the terminal device 120, the network device 110 and the core network element 131 as illustrated in FIG. 1.

As shown in FIG. 4, the terminal device 120 in the inactive state may generate 401 the first MAC CE carrying the first identity of the terminal device 120 such as I-RNTI. In some embodiments, the first MAC CE may further carry the first authentication information for the terminal device 120, and the first identity and the first authentication information are in different fields of the first MAC CE. In some alternative embodiments, the terminal device 120 may further generate 402 the second MAC CE carrying the first authentication information for the terminal device 120. The first authentication information is used to verify the validity of the terminal device 120 at the network device 110. For example, the first authentication information may be in the form of a ShortMAC-I.

In accordance with a determination that uplink data to be transmitted at the terminal device 120 is associated with small and infrequent data traffic, the terminal device 120 may transmit 403 the random preamble sequence, the first MAC CE and the uplink data to the network device 110. In some embodiments, the terminal device 120 may transmit the random preamble sequence in a RACH and transmit the first MAC CE and the uplink data in a PUSCH. In some embodiments where the terminal device 120 is needed to be verified by the network device 110, the terminal device 120 may transmit the random preamble sequence, the first MAC CE, the uplink data and the second MAC CE to the network device 110. In some embodiments, the terminal device 120 may transmit the random preamble sequence, the first MAC CE, the uplink data, the second MAC CE and the BSR to the network device 110.

For the transmission 403, the transmitted information is scrambled by a random access-RNTI (RA-RNTI) and a random access preamble identifier (RAPID). In some embodiments, an extended RAR window may be started, as the network device 110 needs to forward uplink data to the core network element 131, and wait for downlink data from the core network element 131. In some embodiments for the 2-step RACH procedure, the RAR window needs to be further enlarged to 80 ms, 160 ms, 320 ms, 640 ms . . . , which requires 3 bit, 4 bit, 5 bit, 6 bit . . . the least significant bit (LSB) of the system frame number (SFN) is included in the downlink control information (DCI) scheduling message (msgB).

In some embodiments, the extended RAR window may be broadcasted by the system information. In some alternative embodiments, the extended RAR window may be configured to the terminal device 120 by using a dedicated RRC message.

In some embodiments where the terminal device 120 is needed to be verified by the network device 110, the network device 130 may determine the first authentication information from the second MAC CE, and verify 404 the validity of the terminal device 120 based on the first authentication information. In some embodiments, in accordance with a determination that the terminal device 120 is valid, the network device 130 may transmit 405 the uplink data to the core network element 131. In some embodiments, in accordance with a determination that the terminal device 120 is invalid, the network device 130 may discard the uplink data. In some embodiments where there is downlink data that is to be transmitted from the core network element 131, the network device 110 may receive 406 the downlink data from the core network element 131.

The network device 110 may generate 407 contention resolution information and transmit 408 the contention resolution information in a successful RAR to the network device 110. In some embodiments, the contention resolution information may comprise an identity of a terminal device that is successful in contention resolution. In some embodiments, the network device 110 may transmit the contention resolution information in a PDSCH.

Assuming that the contention resolution information comprises the first identity of the terminal device 120. In some embodiments where the network device 110 is needed to be verified at the terminal device 120, the network device 110 may generate a fourth MAC CE carrying second authentication information for the network device 110. For example, the second authentication information may be in the form of a ShortMAC-I. In this case, the network device 110 may transmit the fourth MAC CE with the contention resolution information to the network device 110. In some embodiments, the network device 110 may transmit the fourth MAC CE and the contention resolution information in a PDSCH.

In some embodiments where the network device 110 receives a BSR indicating there is still have remaining uplink data to be transmitted, the network device 110 may transmit uplink grant information with the contention resolution information to the terminal device 120. In some additional embodiments, the network device 110 may transmit the contention resolution information, the fourth MAC CE, and uplink grant information to the terminal device 120. In some embodiments, the network device 110 may transmit the contention resolution information and the fourth MAC CE in a PDSCH and transmit the uplink grant information in a physical downlink control channel (PDCCH).

In some embodiments the network device 110 receives, from the core network element 131, the downlink data destined for the terminal device 120, the network device 110 may transmit the contention resolution information, the fourth MAC CE, the uplink grant information and the downlink data to the network device 110.

Upon receiving the contention resolution information that comprises the first identity of the terminal device 120, the terminal device 120 may perform subsequent data transmission by using the C-RNTI in the successful RAR. In this time, the terminal device 120 is still in the inactive state.

In some embodiments, the terminal device 120 may verify 409 the validity of the network device 110 based on the second authentication information received from the network device 110. If the network device 110 is determined as being valid, the terminal device 120 may accept the received downlink data. If the network device 110 is determined as being invalid, the terminal device 120 may discard the received downlink data.

The terminal device 120 may transmit 410 the at least a part of the remaining uplink data and a BSR to the network device 130. In some embodiments, the terminal device 120 may transmit the remaining uplink data and the BSR in a PDSCH. In some embodiments, the terminal device 120 may monitor, in response to receiving the uplink grant information, a downlink channel until a period of time is expired. In some alternative embodiments, the terminal device 120 may monitor, in response to transmitting 410 at least a part of the remaining uplink data, a downlink channel until a period of time is expired.

Upon receiving the at least a part of the remaining uplink data, the network device 110 may transmit 411 it to the core network element 131. The network device 110 may receive 412 further downlink data and further uplink grant information if any, and transmit 413 them to the terminal device 120. The terminal device 120 may transmit 414 the remaining uplink data to the network device 110 and the network device 110 may transmit 415 it to the core network element 131.

The uplink and downlink data transmission may be repeated as above with C-RNTI in the inactive state of the terminal device 120 until the network device 110 transmits 416 a connection release message that indicates the end of the data transmission. If receiving the connection release message such as a RRCRelease message, the terminal device 120 may initialize the inactive state of the terminal device 120. It can be seen that the operations in steps 409-416 in FIG. 4 are similar with that in steps 311-318 in FIG. 3.

With the processes described with reference to FIGS. 2-4, small data transmission in the inactive state of the terminal device can be well carried out with reduced signaling overhead. Corresponding to these processes, embodiments of the present application also provides methods of communication implemented at a terminal device and a network device respectively. It will be described in more details with reference to FIGS. 5-14.

FIG. 5 illustrates an example method 500 of communication implemented at a terminal device in accordance with some embodiments of the present disclosure. For example, the method 500 may be performed at the terminal device 120 as shown in FIG. 1. For the purpose of discussion, in the following, the method 500 will be described with reference to FIG. 1. It is to be understood that the method 500 may include additional blocks not shown and/or may omit some blocks as shown, and the scope of the present disclosure is not limited in this regard.

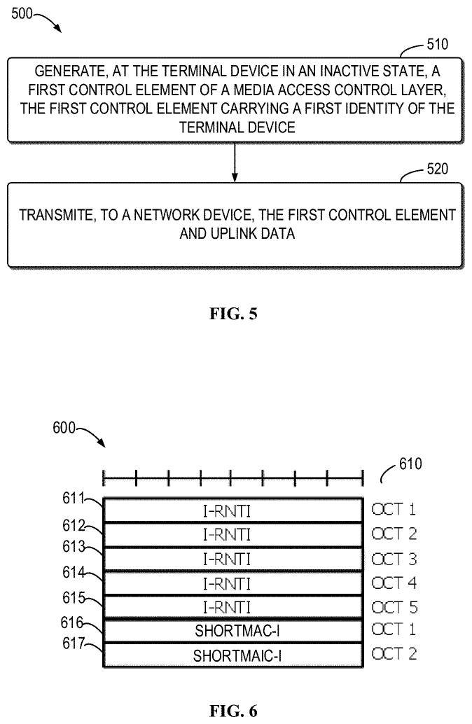

As shown in FIG. 5, at block 510, the terminal device 120 generates a first MAC CE carrying a first identity of the terminal device 120. In some embodiments, the first MAC CE may further carry first authentication information for the terminal device 120, and the first identity and the first authentication information are in different fields of the first MAC CE. FIG. 6 illustrates a schematic diagram 600 illustrating an implementation of a MAC CE 610 carrying a first identity and first authentication information for the terminal device in accordance with some embodiments of the present disclosure.

In some embodiments, the MAC CE 610 may have a fixed size and consist of two fields including an I-RNTI field and a SHORTMAC-I field. The I-RNTI field contains the I-RNTI of the MAC entity of the terminal device 120. In some embodiments, the length of the I-RNTI field may be 40 bits, as shown by the bytes 611-615 in FIG. 6. The SHORTMAC-I field contains an authentication token to facilitate authentication for the terminal device 120 at the network device 110. In some embodiments, the length of the SHORTMAC-I field may be 16 bits, as shown by the bytes 616-617 in FIG. 6.

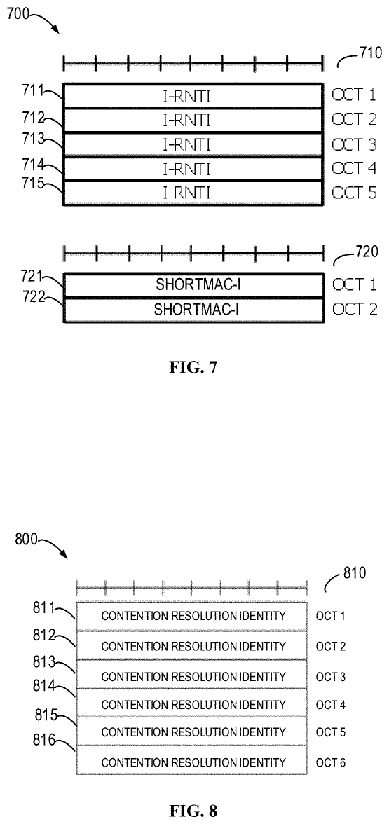

In some alternative embodiments, the terminal device 120 may further generate a second MAC CE carrying the first authentication information for the terminal device 120. The second MAC CE is separated from the first MAC CE. FIG. 7 illustrates a schematic diagram 700 illustrating another implementation of a MAC CE 710 carrying the first identity and a MAC CE 720 carrying the first authentication information in accordance with some embodiments of the present disclosure.

In some embodiments, the MAC CE 710 may have a fixed size and consist of a single field defined as I-RNTI field. This field contains the I-RNTI of the MAC entity of the terminal device 120. In some embodiments, the length of the I-RNTI field may be 40 bits, as shown by the bytes 711-715 in FIG. 7.

In some embodiments, the MAC CE 720 may have a fixed size and consist of a single field defined as SHORTMAC-I field. This field contains an authentication token to facilitate authentication for the terminal device 120 at the network device 110. In some embodiments, the length of the SHORTMAC-I field may be 16 bits, as shown by the bytes 721-722 in FIG. 7.

Return to FIG. 5, at block 520, the terminal device 120 transmits, to the network device 110, the first MAC CE and uplink data. In some embodiments, the uplink data may be associated with small and infrequent data traffic. In some embodiments, the terminal device 120 may transmit the first MAC CE, the second MAC CE and uplink data to the network device 110. In some alternative embodiments, the terminal device 120 may transmit the first MAC CE, the uplink data and a BSR to the network device 110. The BSR may indicate the amount of remaining uplink data that is to be transmitted. In some alternative embodiments, the terminal device 120 may transmit the first MAC CE, the second MAC CE, the uplink data and the BSR to the network device 110.

In some embodiments based on a 2-step RACH procedure, the terminal device 120 may transmit a random preamble sequence, the first MAC CE and the uplink data to the network device 110. In some alternative embodiments, the terminal device 120 may transmit a random preamble sequence, the first MAC CE, the second MAC CE and the uplink data to the network device 110. In some alternative embodiments, the terminal device 120 may transmit a random preamble sequence, the first MAC CE, the uplink data and the BSR to the network device 110. In some alternative embodiments, the terminal device 120 may transmit a random preamble sequence, the first MAC CE, the second MAC

CE, the uplink data and the BSR to the network device 110.

In some embodiments based on a 4-step RACH procedure, the terminal device 120 may transmit a random preamble sequence to the network device 110, and receive, from the network device 110, a RAR for the random preamble sequence. In accordance with the receipt of the RAR, the terminal device 120 may cause the first identity to be carried in the first MAC CE.

In some embodiments, the network device 110 may configure no contention resolution timer or RAR window to the terminal device 120. This means the terminal device 120 just transmits uplink data to the network device 110, and does not wait for any contention resolution.

In some alternative embodiments, the network device 110 may configure extended contention resolution timer or RAR window to the terminal device 120, as described above in connection with the transmission 305 in FIG. 3 and the transmission 403 in FIG. 4. In this case, the terminal device 120 may receive, from the network device 110, contention resolution information.

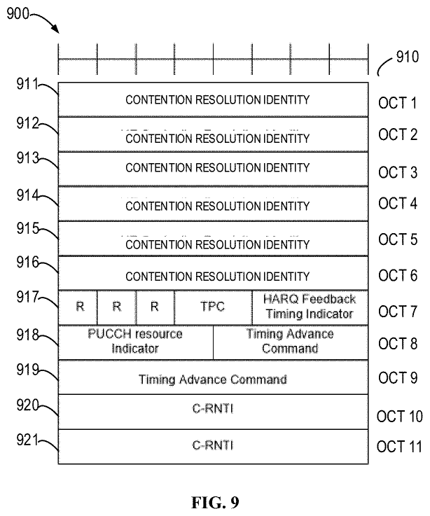

In some embodiments based on a 4-step RACH procedure, a third MAC CE may be defined as FIG. 8 to carry the contention resolution information. FIG. 8 illustrates a schematic diagram 800 illustrating an implementation of a MAC CE 810 carrying contention resolution information for a 4-step RACH procedure in accordance with some embodiments of the present disclosure. In some embodiments, the MAC CE 810 may have a fixed size and consist of a single field defined as a CONTENTION RESOLUTION IDENTITY field. In some embodiments, the length of the CONTENTION RESOLUTION IDENTITY field may be 48 bits, as shown by the bytes 811-816 in FIG. 8.

In some embodiments where the first MAC CE 610 carries both the first identity and the first authentication information as shown in FIG. 6, the CONTENTION RESOLUTION IDENTITY field may contain the UL CCCH SDU or first 48 bits of the first MAC CE, and if the UL CCCH SDU is longer than 48 bits, this field may contain the first 48 bits of the UL CCCH SDU.

In some alternative embodiments where the first MAC CE 710 carries the first identity and the second MAC CE 720 carries the first authentication information as shown in FIG. 7, the CONTENTION RESOLUTION IDENTITY field may contain the UL CCCH SDU or the first MAC CE 710, and if the UL CCCH SDU is longer than 48 bits, this field contains the first 48 bits of the UL CCCH SDU. For the case of the first MAC CE 710, the most significant bit (MSB) of this field should be set as padding bit 0.

In some embodiments based on a 2-step RACH procedure, the contention resolution information may be included in a successful RAR as shown in FIG. 9. FIG. 9 illustrates a schematic diagram 900 illustrating an implementation of a successful RAR 910 carrying contention resolution information for a 2-step RACH procedure in accordance with some embodiments of the present disclosure. In some embodiments, the CONTENTION RESOLUTION IDENTITY field may be included in the successful RAR 910. In some embodiments, the length of the CONTENTION RESOLUTION IDENTITY field may be 48 bits, as shown by the bytes 911-916 in FIG. 9. Other fields 917-921 are similar with that in existing successful RAR, and its details are omitted here.

In some embodiments where the first MAC CE 610 carries both the first identity and the first authentication information as shown in FIG. 6, the CONTENTION RESOLUTION IDENTITY field may contain the UL CCCH SDU or first 48 bits of the first MAC CE, and if the UL CCCH SDU is longer than 48 bits, this field may contain the first 48 bits of the UL CCCH SDU.

In some alternative embodiments where the first MAC CE 710 carries the first identity and the second MAC CE 720 carries the first authentication information as shown in FIG. 7, the CONTENTION RESOLUTION IDENTITY field may contain the UL CCCH SDU or the first MAC CE 710, and if the UL CCCH SDU is longer than 48 bits, this field contains the first 48 bits of the UL CCCH SDU. For the case of the first MAC CE 710, the MSB of this field should be set as padding bit 0.

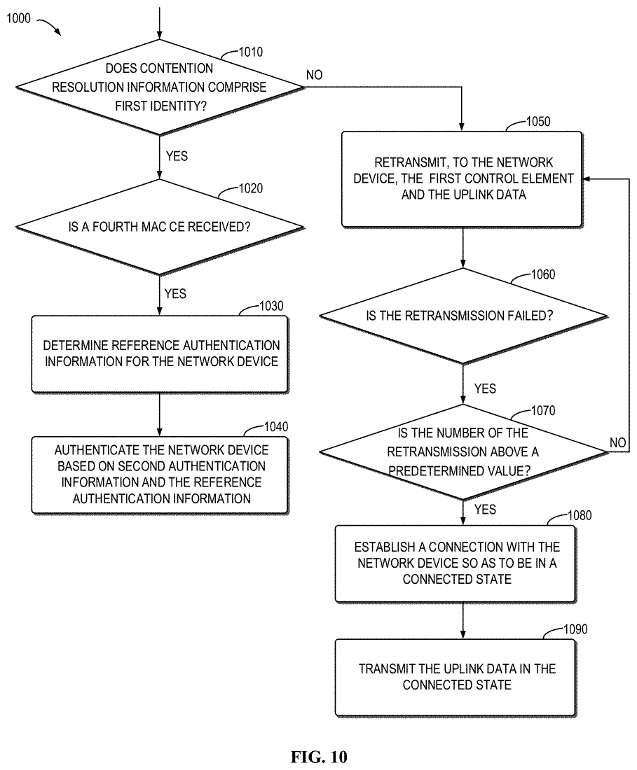

The operations upon receiving the contention resolution information will be further described below with reference to FIG. 10. FIG. 10 illustrates another example method 1000 of communication implemented at a terminal device in accordance with some embodiments of the present disclosure. For example, the method 1000 may be performed at the terminal device 120 as shown in FIG. 1. For the purpose of discussion, in the following, the method 1000 will be described with reference to FIG. 1. It is to be understood that the method 1000 may include additional blocks not shown and/or may omit some blocks as shown, and the scope of the present disclosure is not limited in this regard.

At block 1010, the terminal device 120 may determine whether the contention resolution information comprises the first identity. If the contention resolution information comprises the first identity, the terminal device 120 may, at block 1020, determine whether second authentication information for the network device 110 is received. In some embodiments, the second authentication information may be carried in a fourth MAC CE. The fourth MAC CE may be newly defined as shown by the MAC CE 720 in FIG. 7. In some embodiments, the second authentication information may be carried in the second MAC CE. In this way, the second MAC CE carrying the first authentication information from the terminal device 120 to the network device 110 is reused to carry the second authentication information from the network device 110 to the terminal device 120. Thus, corresponding overhead is further reduced.

If determining that the fourth MAC CE is received, the terminal device 120 may, at block 1030, determine reference authentication information (for example, short MAC-I) for the network device 110. In some embodiments, the terminal device 120 may calculate the short MAC-I value by setting the short MAC-I to the 16 least significant bits of a MAC-I. The MAC-I is calculated i) over the ASN.1 encoded VarSDTMAC-Input; ii) with the K_{RRCint} key in the UE Inactive AS Context and the previously configured integrity protection algorithm; and iii) with all input bits for COUNT, BEARER and DIRECTION set to binary ones.

At block 1040, the terminal device 120 may verify the network device 110 based on the second authentication information and the reference authentication information. In some embodiments, the terminal device 120 may match the reference authentication information calculated itself with the second authentication information received from the network device 110. If the reference authentication information matches with second authentication information, the terminal device 120 may determine that the network device 110 is valid. If the reference authentication information does not match with second authentication information, the terminal device 120 may determine that the network device 110 is invalid, and may discard the downlink data received.

If determining at block 1010 that the contention resolution information does not comprise the first identity, the terminal device 120 may, at block 1050, perform retransmission of the first MAC CE and uplink data. At block 1060, the terminal device 120 may determine whether the retransmission is failed. If determining that the retransmission is failed, the terminal device 120 may, at block 1070, determine whether the number of retransmission is above a predetermined value. In some embodiments, the predetermined value may be broadcasted by system information. In some alternative embodiments, the predetermined value may be configured to the terminal device 120 by a dedicated RRC message.

If the number of retransmission is less than the predetermined value, the terminal device 110 may perform the retransmission again at block 1050. If the number of retransmission is equal to or greater than the predetermined value, the terminal device 120 may determine that the contention fails. In accordance with the determination that the contention fails, the terminal device 120 may, at block 1080, establish a connection with the network device 110 by performing a random access procedure, so that the terminal device 120 is in a connected state.

At block 1090, the terminal device 120 may transmit, to the network device 110, the uplink data in the connected state. In some additional embodiments, the terminal device 120 may also transmit information about the failure of contention associated with transmission of the uplink data to the network device 110. In some embodiments, the information about the failure of contention may comprise a size of the uplink data and a random access procedure used and the like. It should be noted that, the information about the failure of contention is not limited to this.

In this way, if contention resolution is not successful, the terminal device 120 may perform small data retransmission. If the retransmission fails after predetermined times retries, the terminal device 120 may fallback to legacy data transmission, i.e., the terminal device 120 only transmits data after entering the connected state.

The operations upon receiving successful contention resolution will be further described below with reference to FIG. 11. FIG. 11 illustrates another example method 1100 of communication implemented at a terminal device in accordance with some embodiments of the present disclosure. For example, the method 1100 may be performed at the terminal device 120 as shown in FIG. 1. For the purpose of discussion, in the following, the method 1100 will be described with reference to FIG. 1. It is to be understood that the method 1100 may include additional blocks not shown and/or may omit some blocks as shown, and the scope of the present disclosure is not limited in this regard.

At block 1110, the terminal device 120 may determine whether uplink grant information is received. If determining that the terminal device 120 receives the uplink grant information, the terminal device 120 may, at block 1120, determine a second identity of the terminal device 120 for subsequent data transmission. In some embodiments, the second identity may be C-RNTI. In some embodiments based on a 4-step RACH procedure, the second identity may be determined by using TC-RNTI in the RAR as the C-RNTI. In some embodiments based on a 2-step RACH procedure, the second identity may be determined by using C-RNTI included in the successful RAR.

At block 1130, the terminal device 120 may transmit subsequent uplink data to the network device 120 based on the uplink grant information and the second identity. If there are sequential UL data or DL data transmitted by small data transmission, the terminal device 120 will expect to receive UL grant or DL assignment in DCI. At block 1140, the terminal device 120 may monitor a downlink channel associated with the terminal device 120 until a period of time is expired. For example, the downlink channel may be a PDCCH addressed to the C-RNTI.

In some embodiments, the period of time may be a constant value. In some alternative embodiments, the period of time may be broadcasted in system information. In some alternative embodiments, the period of time may be configured by a dedicated RRC message when the terminal device 120 is in a connected state. For example, the dedicated RRC message may be RRCRelease or RRCReconfiguration message, which is stored in the UE context.

In some embodiments, the terminal device 120 may start monitoring the downlink channel in response to receiving uplink grant information, for example, every time upon the reception of uplink grant information for small data transmission after C-RNTI is available. In some alternative embodiments, the terminal device 120 may start monitoring the downlink channel in response to transmitting subsequent uplink data, for example, every time upon the transmission of uplink small data after C-RNTI is available.

In some embodiments where the period of time is expired, the terminal device 120 may stop PDCCH monitoring, and release the C-RNTI. In this case, if there is following uplink small data for transmission, the terminal device 120 has to initiate RACH procedure again. In some embodiments, the PDCCH monitoring is also applicable to small data transmission with RRC signaling.

In some alternative embodiments, the terminal device 120 may use pre-configured grant information to perform subsequent data transmission. In some embodiments, the terminal device 120 may receive, in a connection release message from the network device 110, an indication of configured grant information and a third identity of the terminal device 120 configured in a connected state, and transmit subsequent uplink data to the network device 110 based on the configured grant information and the third identity. For example, based on the indication, the terminal device 120 may obtain the corresponding configured grant information and third identity from the UE context, and perform small data transmission using the obtained configured grant information and third identity. The third identity may be a configured scheduling RNTI (CS-RNTI).

In some alternative embodiments, the terminal device 120 may receive, in a connection release message from the network device 110, new configured grant information and third identity, and perform small data transmission using the received configured grant information and third identity.

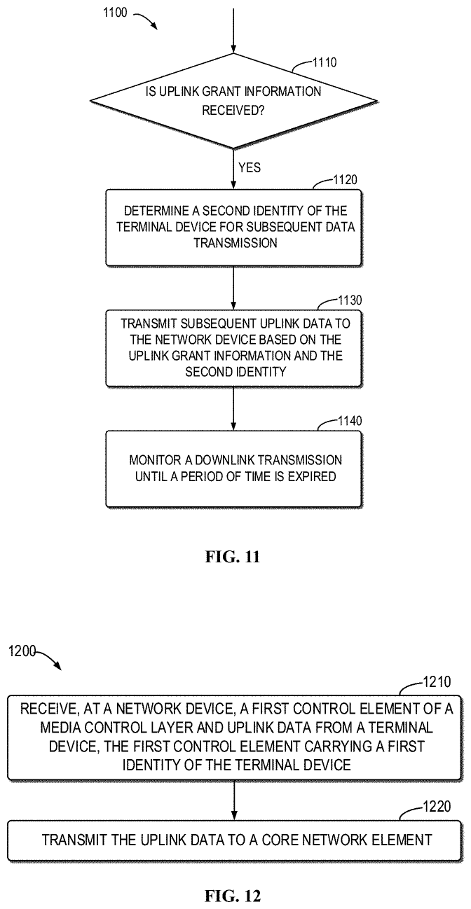

FIG. 12 illustrates an example method 1200 of communication implemented at a network device in accordance with some embodiments of the present disclosure. For example, the method 1200 may be performed at the network device 110 as shown in FIG. 1. For the purpose of discussion, in the following, the method 1200 will be described with reference to FIG. 1. It is to be understood that the method 1200 may include additional blocks not shown and/or may omit some blocks as shown, and the scope of the present disclosure is not limited in this regard.

As shown in FIG. 12, at block 1210, the network device 110 receives a first MAC CE and uplink data from the terminal device 120. The first MAC CE carries a first identity of the terminal device 120 in an inactive state. In some embodiments based on a 2-step RACH procedure, the network device 110 may receive the first MAC CE, the uplink data and a random preamble sequence from the terminal device 120. In some embodiments based on a 4-step RACH procedure, the network device 110 may further receive a random preamble sequence from the terminal device 120, and transmit, to the terminal device 120, a RAR for the random preamble sequence.

At block 1220, the network device 110 transmits the uplink data to the core network element 131. In this way, small data transmission can be well performed in the inactive state of the terminal device 120.

In some embodiments, the first MAC CE may further carry first authentication information for the terminal device 120, and the first identity and the first authentication information are in different fields of the first MAC CE as described in connection with FIG. 6. In some embodiments, the network device 110 may receive, from the terminal device 120, the first MAC CE, the uplink data and a second MAC CE carrying first authentication information for the terminal device 120. The first and second MAC CEs may be defined as shown by MAC CEs 710 and 720 in FIG. 7 respectively.

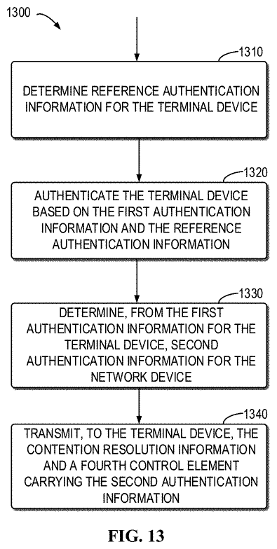

The operations upon receiving the first authentication information will be described with reference to FIG. 13. FIG. 13 illustrates another example method 1300 of communication implemented at a network device in accordance with some embodiments of the present disclosure. For example, the method 1300 may be performed at the network device 110 as shown in FIG. 1. For the purpose of discussion, in the following, the method 1300 will be described with reference to FIG. 1. It is to be understood that the method 1300 may include additional blocks not shown and/or may omit some blocks as shown, and the scope of the present disclosure is not limited in this regard.

At block 1310, the network device 110 may determine reference authentication information for the terminal device 120. In some embodiments, the network device 110 may determine the reference authentication information based on VarSDTMAC-Input as shown below:

| | |
|---|---|
| VarResumeMAC-Input ::= | SEQUENCE { |
| sourcePhysCellId | PhysCellId, |
| targetCellIdentity | CellIdentity, |
| source-c-RNTI | RNTI-Value |

}

At block 1320, the network device 110 may verify the terminal device 120 based on the second authentication information and the reference authentication information. In some embodiments, the network device 110 may match the reference authentication information calculated itself with the first authentication information received from the terminal device 120. If the reference authentication information matches with the first authentication information, the network device 110 may determine that the terminal device 120 is valid. In some embodiments, upon determining that the terminal device 120 is valid, the network device 110 may transmit the uplink data to the core network element 131.

If the reference authentication information does not match with the first authentication information, the network device 110 may determine that the terminal device 120 is invalid. In some embodiments, upon determining that the terminal device 120 is invalid, the network device 110 may discard the uplink data received.

Assuming that the network device 110 is a network device (also referred to as the last serving network device hereinafter) that serves the terminal device 120 immediately before the terminal device 120 enters in the inactive state. At block 1330, the network device 110 may determine, from the first authentication information for the terminal device 120, second authentication information for the network device 110. In some embodiments, the network device 110 may determine the second authentication information by using a physical cell identifier (PCI) for a target cell and using a cell identifier (CID) for source cell, for VarSDTMAC-Input associated with the first authentication information. For example, the VarSDTMAC-Input may be modified as below:

```
VarSDTMAC-Input ::= SEQUENCE {
  sourceCellIdentity CellIdentity,
  targetPhyCellId PhysCellId,
  source-c-RNTI RNTI-Value
}
```

In some alternative embodiments, the network device 110 may determine the second authentication information by changing the order of the parameters in VarSDTMAC-Input associated with the first authentication information. For example, the VarSDTMAC-Input may be modified as below:

```
VarSDTMAC-Input ::= SEQUENCE {
  targetCellIdentity CellIdentity,
  sourcePhysCellId PhysCellId,
  source-c-RNTI RNTI-Value
}
```

In some alternative embodiments, the network device 110 may determine the second authentication information by removing one of the parameters in VarSDTMAC-Input associated with the first authentication information. For example, the VarSDTMAC-Input may be modified as below:

```
VarSDTMAC-Input ::= SEQUENCE {
  sourcePhysCellId PhysCellId,
  source-c-RNTI RNTI-Value
}
```

At block 1340, the network device 110 may transmit the second authentication information to the terminal device 120. In some embodiments, the network device 110 may generate a fourth MAC CE carrying the second authentication information and transmit the contention resolution information and the fourth MAC CE to the terminal device 120. In some embodiments, the fourth MAC CE may be defined as shown by the MAC CE 720 in FIG. 7. In some alternative embodiments, the network device 110 may reuse the second MAC CE for transmission of the second authentication information to the terminal device 120.

In some embodiments where the network device 110 is not the last serving network device for the terminal device 120, the second authentication information may be determined by the last serving network device, and may be transmitted from the last serving network device to the network device 110. For example, the second authentication information may be transmitted in a Xn message such as RETRIEVE UE CONTEXT RESPONSE message, or RETRIEVE UE CONTEXT FAILURE message.

In some embodiments, the network device 110 may receive the first MAC CE, the uplink data and a BSR from the terminal device 120. The BSR indicates the amount of remaining uplink data that is to be transmitted. In accordance with a determination that there is the remaining uplink data, the network device 110 may transmit uplink grant information to the terminal device 120.

In some embodiments, the network device 110 may transmit contention resolution information to the terminal device 120. In some embodiments based on a 4-step RACH procedure, the contention resolution information may be carried in a third MAC CE. In some embodiments based on a 2-step RACH procedure, the contention resolution information may be placed in a random access response message. In some alternative embodiments, the network device 110 may transmit the contention resolution information and the uplink grant information to the terminal device 120. In some additional embodiments, the network device 110 may receive subsequent uplink data based on the uplink grant information and a second identity of the terminal device 120 for subsequent data transmission. The second identity may be C-RNTI.

In some alternative embodiments, the network device 110 may transmit, to the terminal device 120 and in a connection release message, an indication of configured grant information and a third identity of the terminal device 120 configured in a connected state, and receive subsequent uplink data from the terminal device 120 based on the configured grant information and the third identity. The third identity may be CS-RNTI.

In some embodiments, the network device 110 may transmit, to the terminal device 120, an indication of ending data transmission in a connection release message for initialization of the inactive state of the terminal device 120. For example, if the network device 110 wants to end the small data transmission, the network device 110 may transmit, with a RRCRelease message, the indication so as to cause the terminal device 120 to be in the normal inactive state, i.e., initialize parameters in the inactive state. For example, the terminal device 120 is caused to suspend the packet data convergence protocol (PDCP) entity and stop PDCCH monitoring.

In some embodiments, the network device 110 may receive downlink data from the core network element 131, and transmit the contention resolution information and the downlink data to the terminal device 120. In some embodiments where a failure of contention occurs, the network device 110 may receive information about the failure of contention from the terminal device 120.

In some embodiments, the PDCP sequence number (SN) and hyper frame number (HFN) value (also referred to as COUNT value) may be maintained to be counted up with each small data transmission in the inactive state if without explicit RRC signaling. This will avoid the same COUNT value to be used more than once under the same security key, and thus ensure the security during small data transmission. In some embodiments where the network device 110 wants to update the security key for the next small data transmission, the network device 110 may transmit a RRCRelease message with a next hop chaining counter (NCC).

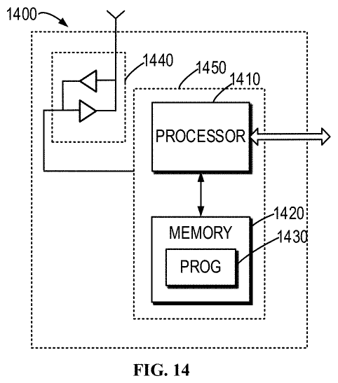

FIG. 14 is a simplified block diagram of a device 1400 that is suitable for implementing embodiments of the present disclosure. The device 1400 can be considered as a further example implementation of the network device 110 or the terminal device 120 as shown in FIG. 1. Accordingly, the device 1400 can be implemented at or as at least a part of the network device 110 or the terminal device 120.

As shown, the device 1400 includes a processor 1410, a memory 1420 coupled to the processor 1410, a suitable transmitter (TX) and receiver (RX) 1440 coupled to the processor 1410, and a communication interface coupled to the TX/RX 1440. The memory 1410 stores at least a part of a program 1430. The TX/RX 1440 is for bidirectional communications. The TX/RX 1440 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1430 is assumed to include program instructions that, when executed by the associated processor 1410, enable the device 1400 to operate in accordance with the embodiments of the present disclosure, as discussed herein with reference to FIGS. 1 to 13. The embodiments herein may be implemented by computer software executable by the processor 1410 of the device 1400, or by hardware, or by a combination of software and hardware. The processor 1410 may be configured to implement various embodiments of the present disclosure. Furthermore, a combination of the processor 1410 and memory 1420 may form processing means 1450 adapted to implement various embodiments of the present disclosure.

The memory 1420 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1420 is shown in the device 1400, there may be several physically distinct memory modules in the device 1400. The processor 1410 may be of any type suitable to the local technical network, and may include one or more of general purpose computers, special purpose computers, microprocessors, digital signal processors (DSPs) and processors based on multicore processor architecture, as non-limiting examples. The device 1400 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 13. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-40. (canceled)

41. A method performed by a user equipment (UE), the method comprising:
initiating a procedure for Small Data Transmission (SDT); and
monitoring a Physical Downlink Control Channel (PDCCH) addressed to a Cell Radio Network Temporary Identifier (C-RNTI) of the UE, while remaining in an inactive state.

42. The method of claim 41, wherein the UE monitors the PDCCH addressed to the C-RNTI until expiry of a timer.

43. The method of claim 42, wherein a value of the timer is broadcasted in system information.

44. The method of claim 41, wherein the UE monitors the PDCCH addressed to the C-RNTI until reception of a Radio Resource Control (RRC) Release message.

45. The method of claim 41, further comprising:
receiving a Radio Resource Control (RRC) Release message comprising a Configured Scheduling RNTI (CS-RNTI), wherein the UE initiates the procedure for the SDT based on the CS-RNTI; and
performing the SDT based on a configured grant.

46. The method of claim 41, wherein at least one of an uplink grant or a downlink assignment is carried in a DCI transmitted in the PDCCH addressed to the C-RNTI, and
the UE performs the SDT based on at least one of the uplink grant or the downlink assignment.

47. The method of claim 46, wherein the UE performs a subsequent uplink transmission based on the uplink grant.

48. The method of claim 41, wherein the UE initiates the procedure of the SDT with a transmission over Random Access Channel (RACH).

49. A method performed by a base station, the method comprising:
communicating with a user equipment (UE); and
during a procedure for Small Data Transmission (SDT), transmitting a Physical Downlink Control Channel (PDCCH) addressed to a Cell Radio Network Temporary Identifier (C-RNTI) of the UE, while the UE is in an inactive state.

50. The method of claim 49, wherein the PDCCH addressed to the C-RNTI is monitored by the UE until expiry of a timer.

51. The method of claim 50, wherein a value of the timer is broadcasted in system information.

52. The method of claim 49, wherein the PDCCH addressed to the C-RNTI is monitored by the UE until a Radio Resource Control (RRC) Release message is received by the UE.

53. The method of claim 49, further comprising:
transmitting a Radio Resource Control (RRC) Release message comprising a Configured Scheduling RNTI (CS-RNTI), wherein the procedure for the SDT is initiated based on the CS-RNTI,
wherein the SDT is performed based on a configured grant.

54. The method of claim 49, wherein at least one of an uplink grant or a downlink assignment is carried in a DCI transmitted in the PDCCH addressed to the C-RNTI, and
the SDT is performed based on at least one of the uplink grant or the downlink assignment.

55. The method of claim 54, wherein a subsequent uplink transmission is performed based on the uplink grant.

56. The method of claim 49, wherein the procedure of the SDT is initiated with a transmission over Random Access Channel (RACH).

57. A user equipment (UE) comprising:
a memory configured to store instructions: and
a processor configured to execute the instructions to:
initiate a procedure for Small Data Transmission (SDT); and
monitor a Physical Downlink Control Channel (PDCCH) addressed to a Cell Radio Network Temporary Identifier (C-RNTI) of the UE, while remaining in an inactive state.

58. The UE of claim 57, wherein the processor is configured to execute the instructions to monitor the PDCCH addressed to the C-RNTI until expiry of a timer.

59. The UE of claim 58, wherein a value of the timer is broadcasted in system information.

60. The UE of claim 57, wherein the processor is configured to execute the instructions to monitor the PDCCH addressed to the C-RNTI until reception of a Radio Resource Control (RRC) Release message.
